(19) United States
(12) Patent Application Publication
(10) Pub. No.: US 2024/0388894 A1
(43) Pub. Date: Nov. 21, 2024

(54) PERFORMING A USER EQUIPMENT PARAMETERS UPDATE CAPABILITY CHECK

(71) Applicant: Lenovo (Singapore) Pte. Ltd., New Tech Park (SG)

(72) Inventors: Sheeba Backia Mary Baskaran, Friedrichsdorf (DE); Roozbeh Atarius, La Jolla, CA (US); Andreas Kunz, Ladenburg (DE)

(21) Appl. No.: 18/688,700

(22) PCT Filed: Sep. 1, 2022
(86) PCT No.: PCT/IB2022/058238

§ 371 Date: Mar. 1, 2024

Related U.S. Application Data
(60) Provisional application No. 63/240,207, filed on Sep. 2, 2021.

(51) Int. Cl. H04W 8/24; H04W 12/06

(52) U.S. Cl. CPC H04W 8/24; H04W 12/06

(57) ABSTRACT

Apparatuses, methods, and systems are disclosed for performing a user equipment (“UE”) parameters update (“UPU”) capability check. One method includes determining, at a first network function, to invoke a UE UPU capability check as part of a UPU procedure in response to UE capabilities not being available to provide a data set type. The method includes transmitting a first message to a second network function, wherein the first message includes: UPU priority information, UPU capability check required information, required UPU data type support information, or a combination thereof. The method includes receiving a second message from the second network function. The second message includes an authentication server function (“AUSF”) UPU medium access control (“MAC”) integrity (“I”) (“UPU-MAC-IAUSF”) and a UE UPU expected MAC (“XMAC”) I (“UPU-XMAC-IUE”).

### CROSS-REFERENCE TO RELATED APPLICATIONS

This application claims priority to U.S. Patent Application Ser. No. 63/240,207 entitled “APPARATUSES, METHODS, AND SYSTEMS FOR UPU CAPABILITY NEGOTIATION TO SUPPORT UPU INVOLVING DIFFERENT DATA SET TYPES IN 5GS” and filed on Sep. 2, 2021 for Sheeba Backia Mary Baskaran et al., which is incorporated herein by reference in its entirety.

### FIELD

The subject matter disclosed herein relates generally to wireless communications and more particularly relates to performing a user equipment (“UE”) parameters update (“UPU”) capability check.

### BACKGROUND

In certain wireless communications systems, a UPU procedure may be performed. In such systems, the UPU procedure may have various corresponding parameters.

### BRIEF SUMMARY

Methods for performing a UPU capability check are disclosed. Apparatuses and systems also perform the functions of the methods. One embodiment of a method includes determining, at a first network function, to invoke a UE UPU capability check as part of a UPU procedure in response to UE capabilities not being available to provide a data set type. In some embodiments, the method includes transmitting a first message to a second network function, wherein the first message includes: UPU priority information, UPU capability check required information, required UPU data type support information, or a combination thereof. In certain embodiments, the method includes receiving a second message from the second network function. The second message includes an authentication server function (“AUSF”) UPU medium access control (“MAC”) integrity (“I”) (“UPU-MAC-I_{AUSF}”) and a UE UPU expected MAC (“XMAC”) I (“UPU-XMAC-I_{UE}”).

One apparatus for performing a UPU capability check includes a processor to determine to invoke a UE UPU capability check as part of a UPU procedure in response to UE capabilities not being available to provide a data set type. In some embodiments, the apparatus includes a transmitter to transmit a first message to a second network function, wherein the first message includes: UPU priority information, UPU capability check required information, required UPU data type support information, or a combination thereof. In various embodiments, the apparatus includes a receiver to receive a second message from the second network function. The second message includes an UPU-MAC-I_{AUSF} and a UPU-XMAC-I_{UE}.

Another embodiment of a method for performing a UPU capability check includes receiving, at a second network function, a first message from a first network function. The first message includes: UPU priority information, UPU capability check required information, required UPU data type support information, or a combination thereof. In some embodiments, the method includes transmitting a second message to the first network function. The second message includes an UPU-MAC-I_{AUSF} and a UPU-XMAC-I_{UE}.

Another apparatus for performing a UPU capability check includes a receiver to receive a first message from a first network function. The first message includes: UPU priority information, UPU capability check required information, required UPU data type support information, or a combination thereof. In some embodiments, the apparatus includes a transmitter to transmit a second message to the first network function. The second message includes an UPU-MAC-I_{AUSF} and a UPU-XMAC-I_{UE}.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing a UPU capability check;

FIG. 2 is a schematic block diagram illustrating one embodiment of an apparatus that may be used for performing a UPU capability check;

FIG. 3 is a schematic block diagram illustrating one embodiment of an apparatus that may be used for performing a UPU capability check;

FIG. 4 is a schematic block diagram illustrating one embodiment of a system for performing a UPU procedure;

FIG. 5 is a schematic block diagram illustrating one embodiment of a system for extension of a UPU procedure to protect a UE sending capabilities within UPU acknowledgment (“ACK”) responses;

FIG. 6 is a schematic block diagram illustrating one embodiment of a system for protection of a UE capabilities indication within a registration procedure;

FIG. 7 is a schematic block diagram illustrating one embodiment of a system for performing a home network (“HN”) parameter update procedure;

FIG. 8 is a schematic block diagram illustrating one embodiment of a system for performing a UE's UPU capability check based on usage of UPU data provisioned by a UDM;

FIG. 9 is a schematic block diagram illustrating one embodiment of UE parameters update header for UE parameters update data type with value “0” (e.g., network to UE);

FIG. 10 is a schematic block diagram illustrating one embodiment of UE parameters update header for UE parameters update data type with value “1” (e.g., UE to network);

FIG. 11 is a schematic block diagram illustrating one embodiment of required and/or expected UE parameters update data set type(s) (e.g., network to UE);

FIG. 12 is a schematic block diagram illustrating one embodiment of UE parameters update data set type(s) supported by the UE (e.g., UE to network);

FIG. 13 is a flow chart diagram illustrating one embodiment of a method for performing a UPU capability check; and

FIG. 14 is a flow chart diagram illustrating another embodiment of a method for performing a UPU capability check.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

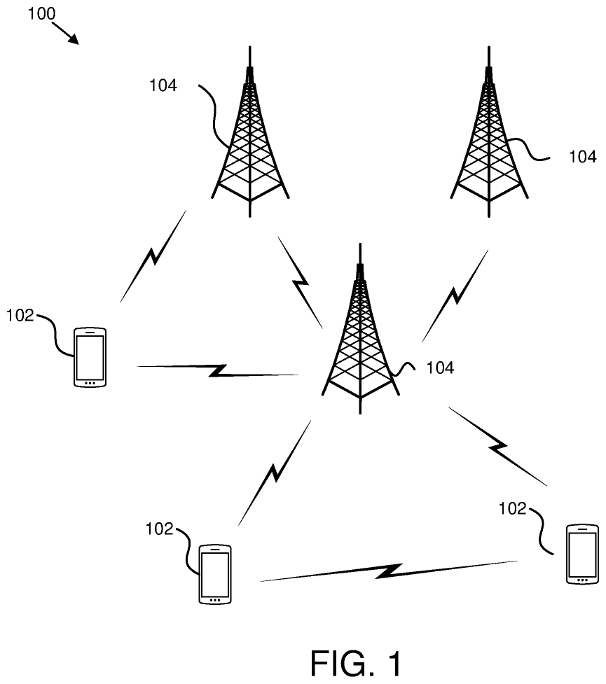

FIG. 1 depicts an embodiment of a wireless communication system 100 for performing a UPU capability check. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may determine to invoke a UE UPU capability check as part of a UPU procedure in response to UE capabilities not being available to provide a data set type. In some embodiments, the network unit 104 may transmit a first message to a second network function, wherein the first message includes: UPU priority information, UPU capability check required information, required UPU data type support information, or a combination thereof. In certain embodiments, the network unit 104 may receive a second message from the second network function. The second message includes an AUSF UPU-MAC-I_{AUSF} and a UPU-XMAC-I_{UE}. Accordingly, the network unit 104 may be used for performing a UPU capability check.

In certain embodiments, a network unit 104 may receive a first message from a first network function. The first message includes: UPU priority information, UPU capability check required information, required UPU data type support information, or a combination thereof. In some embodiments, the network unit 104 may transmit a second message to the first network function. The second message includes an UPU-MAC-I_{AUSF} and a UPU-XMAC-I_{UE}. Accordingly, the network unit 104 may be used for performing a UPU capability check.

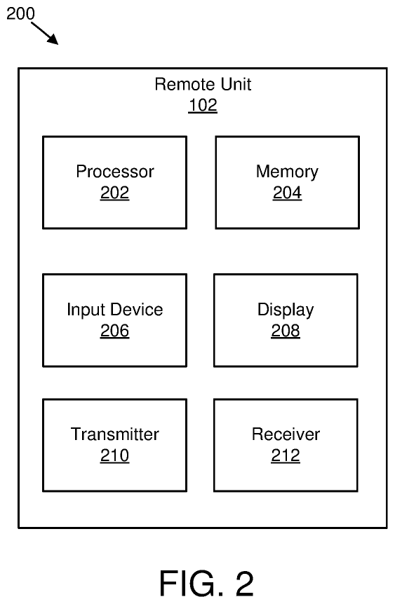

FIG. 2 depicts one embodiment of an apparatus 200 that may be used for

performing a UPU capability check. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

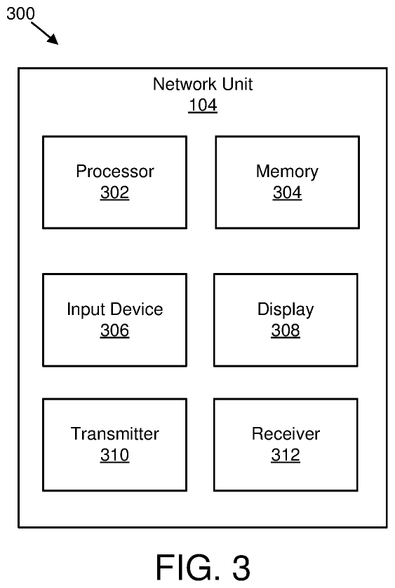

FIG. 3 depicts one embodiment of an apparatus 300 that may be used for performing a UPU capability check. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 to determine to invoke a UE UPU capability check as part of a UPU procedure in response to UE capabilities not being available to provide a data set type. In some embodiments, the transmitter 310 to transmit a first message to a second network function. The first message includes: UPU priority information, UPU capability check required information, required UPU data type support information, or a combination thereof. In various embodiments, the receiver 312 to receive a second message from the second network function. The second message includes an UPU-MAC-I_{AUSF} and a UPU-XMAC-I_{UE}.

In some embodiments, a receiver 312 to receive a first message from a first network function, wherein the first message includes: UPU priority information, UPU capability check required information, required UPU data type support information, or a combination thereof. In some embodiments, the transmitter 310 to transmit a second message to the first network function. The second message includes an UPU-MAC-I_{AUSF} and a UPU-XMAC-I_{UE}.

It should be noted that one or more embodiments described herein may be combined into a single embodiment.

In certain embodiments, a UPU procedure may be used by a UDM for provisioning a routing identifier (“ID”) and default single (“S”) network slice selection assistance information (“NSSAI”) (“S-NSSAI”) and also for updating the routing ID and default configured NSSAI with a transmission to a UE. In some embodiments, new parameters with different data set types (e.g., provisioning of network slice specific authentication and authorization (“NSSAA”) credentials, protocol data unit (“PDU”) session authentication credentials, stand-alone non-public network (“SNPN”) credentials, and so forth) may be provided to the UE by the UDM to support vertical service requirements.

In various embodiments, for a UPU, if a UE doesn't support UPU data set types provided by a UDM, then the UPU will eventually fail.

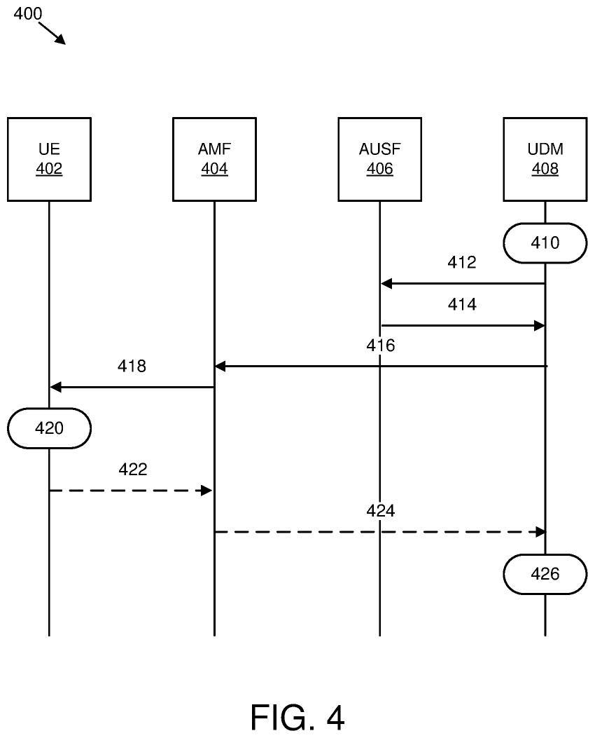

FIG. 4 is a schematic block diagram illustrating one embodiment of a system 400 for performing a UPU procedure. The system 400 includes a UE 402, an AMF 404, an AUSF 406, and a UDM 408. Each of the communications in the system 400 may include one or more messages.

The UDM 408 decides 410 to perform a UE parameter update.

In a first communication 412, the UDM 408 transmits an Nausf_UPUProtection message which may include: a subscription permanent identifier (“SUPI”), UPU data, and/or an ACK indication. In a second communication 414, the AUSF 406 transmits an Nausf_UPUProtection response message which may include: an AUSF UPU medium access control (“MAC”) integrity (“I”) (“UPU-MAC-I_{AUSF}”), a UE UPU expected MAC (“XMAC”) I (“UPU-XMAC-I_{UE}”), and/or a UPU counter (“Counterupu”).

In a third communication 416, the UDM 408 transmits a Nudm_SDM_Notification message that may include: UPU data, the UPU-MAC-I_{AUSF}, and the Counter_{UPU}. In a fourth communication 418, the AMF 404 transmits a DL non-access stratum (“NAS”) transport message that may include: the UPU data, the UPU-MAC-I_{AUSF}, and the Counter_{UPU}. The UE 402 verifies 420 the UPU-MAC-I_{AUSF}.

In an optional fifth communication 422, the UE 402 transmits an UL NAS transport message that may include UPU-MAC-I_{UE}. Moreover, in an optional sixth communication 424, the AMF 404 may transmit an Nudm_SDM_Info message that may include the UPU-MAC-I_{UE}. The UDM 408 may compare 426 the received UPU-MAC-I_{UE} with a stored UPU-XMAC-I_{UE}.

In FIG. 4, the UPU procedure may not support UE capability based UPU data provisioning.

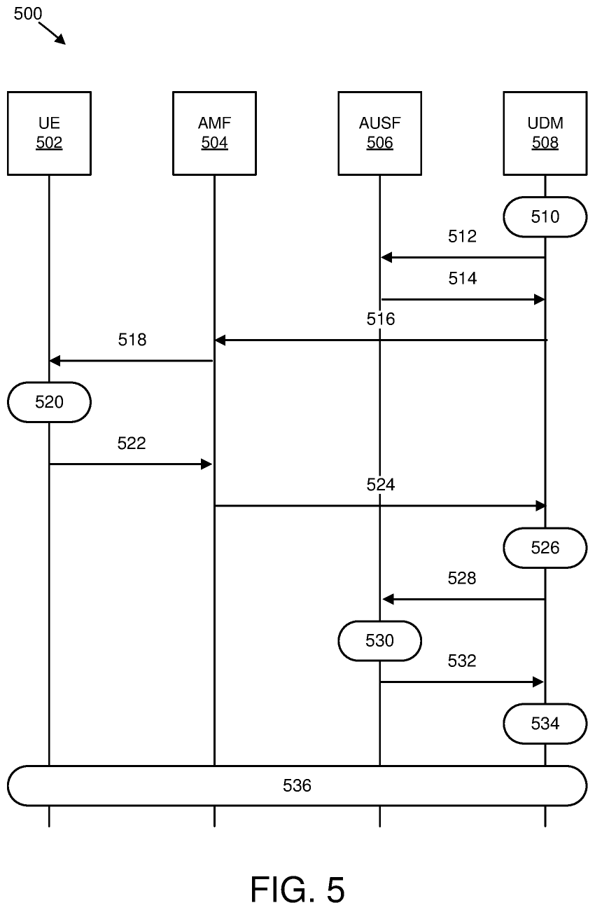

FIG. 5 is a schematic block diagram illustrating one embodiment of a system 500 for extension of a UPU procedure to protect a UE sending capabilities within a UPU ACK responses. The system 500 includes a UE 502, an AMF 504, an AUSF 506, and a UDM 508. Each of the communications in the system 500 may include one or more messages.

The UDM 508 decides 510 to perform a UE parameter update for additional UPU parameters.

In a first communication 512, the UDM 508 transmits an Nausf_UPUProtection_Protect request message which may include: a SUPI, UPU data (e.g., an ACK indication, a UE capability request indication, and so forth), and/or an ACK indication. In a second communication 514, the AUSF 506 transmits an Nausf_UPUProtection_Protect response message which may include: UPU-MAC-I_{AUSF}, UPU-XMAC-I_{UE}, and/or Counter_{UPU}.

In a third communication 516, the UDM 508 transmits a Nudm_SDM_Notification message that may include: UPU data, the UPU-MAC-I_{AUSF}, and the Counter_{UPU}. In a fourth communication 518, the AMF 504 transmits a DL NAS transport message that may include: the UPU data, the UPU-MAC-I_{AUSF}, and the Counter_{UPU}. The UE 502 verifies 520 the UPU-MAC-I_{AUSF}.

In a fifth communication 522, the UE 502 transmits an UL NAS transport message that may include an ACK response (e.g., including a UE capability indication) and UPU-MAC-I_{UE}. Moreover, in a sixth communication 524, the AMF 504 may transmit an Nudm_SDM_Info message that may include an ACK response and the UPU-MAC-I_{UE}. The UDM 508 may, if there is no UE capabilities indication, compare 526 the received UPU-MAC-I_{UE} with a stored UPU-XMAC-I_{UE}; otherwise, the UDM 508 may omit the stored UPU-XMAC-I_{UE} and request a UPU-XMAC-I_{UE} from the AUSF 506 corresponding to the UE capabilities indication provided by the UE 502.

In a seventh communication 528, the UDM 508 transmits an Nausf_UPUProtection_ProtectACK that may include a SUPI, and an ACK response (e.g., including the UE capabilities indication). The AUSF 506 generates 530 a new UPU-XMAC-I_{UE}. In an eighth communication 532, the AUSF 506 transmits an Nausf_UPUProtection_ProtectACK response message that includes the new UPU-XMAC-I_{UE}. The UDM 508 compares 534 the received UPU-MAC-I_{UE} from the UE 502 with the new UPU-XMAC-I_{UE} received from the AUSF 506. The UDM 508 stores the supported UE parameters update data set types if the verification is successful. In a ninth communication 536, another round of steps 510 through 526 is performed for the new parameter updated according to the received UE capabilities indication.

In FIG. 5, the UPU procedure has to be run twice, such as one round of the UPU procedure to perform a UE capability check and another round of the UPU procedure to perform the actual provisioning of UPU data, which incurs more computational complexity.

In FIG. 5, the ACK and a UE capabilities request indicator are included, and a UPU data container is defined to hold only UE parameters to be provisioned by the UDM 508. Therefore, on a successful verification of UPU-MAC-I_{AUSF}, the UE 502 can wrongly store the ACK and the UE capabilities request indicator as UPU data, but this is not the actual UPU data by itself. The wrong storage of information as UPU data may be made in the UE 502 because the UE 502 does not analyze the UPU data if the verification of UPU-MAC-I_{AUSF} is successful. The UE 502 forwards secured packet to a universal subscriber identity module (“USIM”). If the verification of UPU-MAC-I_{AUSF} is successful and the UPU data contains any parameters that are not protected by a secure packet, the UE 502 updates its stored parameters with received parameters in UDM updated data.

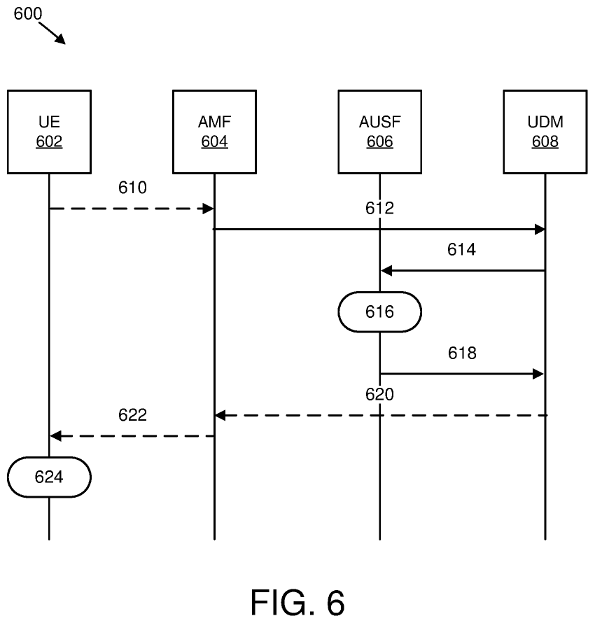

FIG. 6 is a schematic block diagram illustrating one embodiment of a system 600 for protection of a UE capabilities indication within a registration procedure. The system 600 includes a UE 602, an AMF 604, an AUSF 606, and a UDM 608. Each of the communications in the system 600 may include one or more messages.

In a first optional communication 610, the UE 602 sends a registration request message that may include a UPU capability container. In a second communication 612, the AMF 604 transmits a Nudm_UECM_Registration message that may include the UPU capability container. In a third communication 614, the UDM 608 transmits a Nausf_UPUCVerfication message that may include a SUPI, supported UE parameters update data set types, a UPUC-MAC-I_{UE}, and/or a Counter_{UPUC} (e.g., ACK indication). The AUSF 606 verifies 616 the UPUC-MAC-I_{UE}. In a fourth communication 618, the AUSF 606 transmits an Nausf_UPUCVerification response message that may include a result and/or a UPUC-MAC-I_{AUSF}.

In an optional fifth communication 620, the UDM 608 transmits an Nudm_UECM_Registration response message that may include the UPUC-MAC-I_{AUSF}. In an optional sixth communication 622, the AMF 604 transmits a registration accept message that may include the UPUC-MAC-I_{AUSF}. The UE 602 compares 624 the received UPUC-MAC-I_{AUSF} With a stored UPUC-XMAC-I_{AUSF}.

In FIG. 6, the UDM may need to perform UPU when there is a certain triggering condition (e.g., if it is required to provide NSSAA credentials/PDU session authentication credentials/optionally SNPN credentials etc.,.) and a UE's UPU capability check and UPU may not be required corresponding to every registration of the UE. Therefore, forcing the UE to generate UPU capability container when it is not required to perform any UPU from the UDM side will lead to mere resource wastage.

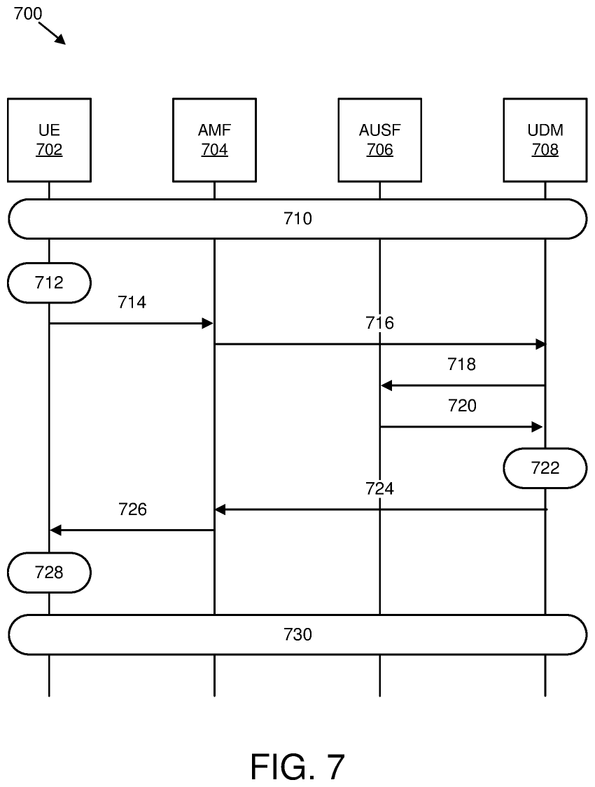

FIG. 7 is a schematic block diagram illustrating one embodiment of a system 700 for performing a HN parameter update procedure. The system 700 includes a UE 702, an AMF 704, an AUSF 706, and a UDM 708. Each of the communications in the system 700 may include one or more messages.

In a first communication 710, the UE 702 is authenticated and registered in a fifth generation core network (“5GC”). The UE 702 and the AUSF 706 share a Kausf. The UE 702 needs 712 to update information in the HN (e.g., UE capabilities). The UE 702 generates an HN parameter update (“HoPU”)-MAC-I_{UE} and Counter_{HoPU}. In a second communication 714, the UE 702 transmits an UL NAS transport message that may include Ho PU data, the HoPU-MAC-I_{UE}, and the Counter_{HoPU}. In a third communication 716, the AMF 704 transmits a Nudm_ParameterProvision message that includes a SUPI, HoPU data, the HoPU-MAC-I_{UE}, and the Counter_{HoPU}.

In a fourth communication 718, the UDM 708 transmits a Nausf_HoPUProtection_Protect request message that may include the SUPI, the HoPU data (e.g., HoPU data, the Counter_{HoPU} (e.g., including an ACK indication), and/or additional information). In a fifth communication 720, the AUSF 706 transmits a Nausf_HoPUProtection_Protect response message that may include the HoPU-MAC-I_{UE} and/or the HoPU-MAC-I_{AUSF}. The UDM 708 compares 722 the HoPU-MAC-I_{UE} from the UE 702 with the HoPU-MAC-I_{UE} from the AUSF 706.

In a sixth communication 724, the UDM 708 transmits a Nudm_ParameterProvision message that may include a result, the HoPU-MAC-I_{AUSF}, and/or additional information. In a seventh communication 726, the AMF 704 transmits a DL NAS transport message that may include the HoPU-MAC-I_{AUSF} and/or additional information. The UE 702 verifies 728 the HoPU-MAC-I_{AUSF}. In an eighth communication 730, the UDM 708 stores the received HoPU data and uses it accordingly (e.g., to initiate a UPU procedure for UPU data types).

FIG. 7 illustrates a mechanism based on the same principles of a UPU procedure, but it operates in an opposite direction (e.g., from UE 702 to HN). A new HoPU procedure is independent of the UPU and/or registration procedure but may be triggered in relation to these.

In FIG. 7, if the UDM 708 needs to provision any UE parameters to the UE 702, then waiting for any indefinite period of time for the UE 702 to initiate the HN parameter update procedure may impact quality of service and may lead to denial of service.

In various embodiments, the UPU procedure may be enhanced to support UE's UPU capability check as part of the UPU procedure and may allow the UE to store new UPU data if the UE is capable to support and/or handle the corresponding UPU data types.

In a first embodiment, there may be enhancements to a UPU procedure to support a UE's capability (e.g., UPU data set type support capability) check based storing and usage of UPU data provisioned by a UDM.

The first embodiment describes enhancements to the UPU procedure to perform the UE's UPU capability check as part of the UPU procedure and to allow the UE to store the new UPU data if the UE is capable of supporting and/or handling corresponding UPU data types. This means the UE is taking the decision based on its capabilities and the requested UPU data types and gives back an indication about whether it supports the requested and/or required UPU data set types. The features in the first embodiment include the following:
1) an AUSF (on request from a UDM) generates UPU-MAC-I_{AUSF} using the inputs related to ‘UPU Priority Information/UPU Capability Check Required Indication’, ‘UE parameters update header information’, and ‘Required UPU data set type(s) Information’. ‘Required UPU data set type(s) Information’ is the list of data set types which the UE has to support in order to successfully process UE parameters and/or data (e.g., provisioning data). Further, the AUSF, on receiving an Acknowledgement required indication from the UDM, generates the UPU-XMAC-I_{UE} from a K_{AUSF} key using inputs described herein;
2) the UDM sending ‘the UPU Priority Information’ (e.g., ‘the UPU Capability Check Required Indication’ and ‘the required UPU data set type(s) information’) corresponding to the UPU provisioning to the UE via the AMF;
3) the UE, on receiving ‘the UPU Priority Information’ (e.g., ‘the UPU Capability Check Required Indication’ and ‘the required UPU data set type(s) information’), determines to perform the UPU capability check considering its capability to support one or more of UPU data set type(s) based on the received ‘required set of UPU data set type(s) information’. If the UPU capability check at the UE is successful, then the UE determines to store and use the UPU data provisioned (e.g., in the UPU data container) by the UDM (via the AMF);
4) on a successful UPU-MAC-I_{AUSF} verification and successful UPU capability

check, the UE generates the UPU-MAC-I_{UE} using inputs related to UPU acknowledgements (e.g., that it verified the parameters update data and UPU capability) and UE parameters update header, respectively. Further the UE also provides ‘the UPU capability check success indication’ to the UDM via the AMF in the acknowledgement response message. The UE may also generate a negative acknowledgement if the UPU capability check fails, and may include its UPU data set type capabilities so that the UDM can retry only with the supported UPU data set types; and
5) the UDM, on receiving the ‘UPU capability check success indication’, checks if the received UPU-MAC-I_{UE} matches the stored UPU-XMAC-I_{UE}, or else the UDM sends the received ‘UPU capability check success indication’ along with other received data to the AUSF to perform UPU-MAC-I_{UE} verification.

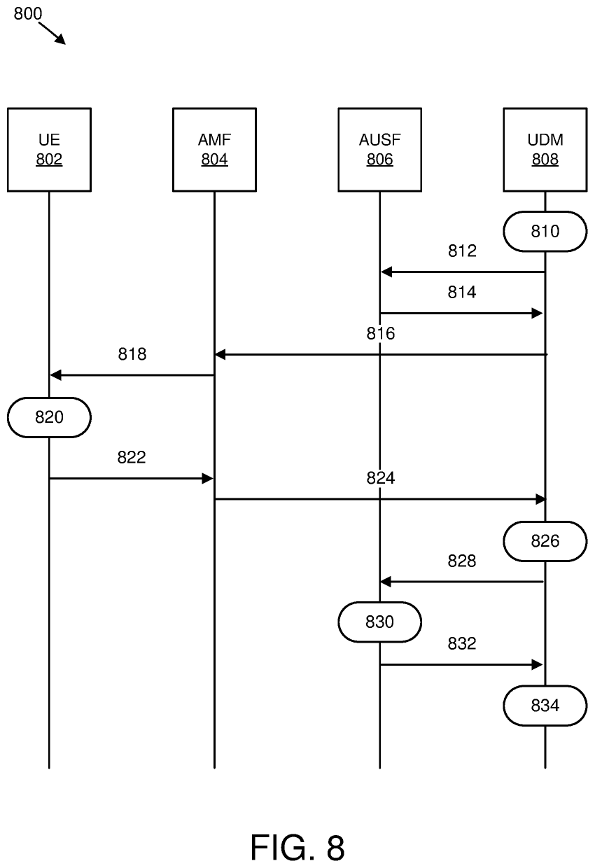

FIG. 8 is a schematic block diagram illustrating one embodiment of a system 800 for performing a UE's UPU capability check based on usage of UPU data provisioned by a UDM. The system 800 includes a UE 802, an AMF 804, an AUSF 806, and a UDM 808. Each of the communications in the system 800 may include one or more messages.

The UDM 808 may decide to perform a UE parameter update any time after the UE 802 has been successfully authenticated and registered to a 5G system. The security procedure enhancements for the UE parameters update shown in FIG. 8 is described herein.

The UDM 808 decides 810 to perform the UPU using a control plane procedure while the UE 802 is registered to a 5G system. If the final consumer of any of the UE parameters to be updated (e.g., the updated routing ID data, provisioning of NSSAA credentials, PDU session authentication credentials, and/or SNPN credentials) is the USIM, the UDM 808 protects these parameters using a secured packet mechanism to update the parameters stored on the USIM. The UDM 808 then prepare the UPU data by including the parameters protected by the secured packet, if any, as well as any UE parameters for which final consumer is the mobile equipment (“ME”). If the UDM 808 determines to provision the UE with parameters with different data type(s) (e.g., UPU dataset types such as: provisioning of NSSAA credentials, PDU session authentication credentials, and/or SNPN credentials), then the UDM 808, based on local policy, determines to initiate UE UPU capability check along with the UPU procedure to enable the provisioning of UPU data if those UPU data set types are supported by the UE 802.

In a first communication 812 and a second communication 814, the UDM 808 may invoke a Nausf_UPUProtection service operation message by including UPU data (i.e., the UPU data list and UPU header) in a transmission to the AUSF 806 to get UPU-MAC-I_{AUSF} and Counter_{UPU}. The UDM 808 select the AUSF 806 that holds the latest K_{AUSF} of the UE 802. If the UDM 808 determines to provision the UE 802 with parameters of different data types, and if the UDM 808 is not aware of the UE's UPU data set type support and/or capabilities, then the UDM 808 performs the following:
1) the UDM 808 sends the ‘UPU Priority Information’ to the AUSF 806 in the Nausf_UPUProtection service operation message (e.g., Nausf_UPUProtection_Protect request). The ‘UPU Priority Information’ may contain the ‘UPU capability check required’ indication, ‘Required UPU data type(s) support information’, and ‘UPU capability Request’ indication. The ‘Required UPU data type(s) support information’ may include a list of one or more UPU data set type(s) information required to be supported at the UE 802 to perform a successful UPU procedure corresponding to the required parameter provisioning as determined by the UDM 808;
2) if the UDM 808 determines to provision the UE 802 with parameters of different data types and if the UDM 808 determines to invoke a UPU capability check at the UE 802, then the UDM 808 decides that the UE 802 is required to acknowledge the successful security check of the UPU priority information, received UE parameters update data, and successful UPU capability check at the UE 802, then the UDM 808 sets the corresponding indication in the UE parameters update data (e.g., ACK in the UPU header) and include the ACK indication in the Nausf_UPUProtection service operation message to signal that it also needs the expected UPU-XMAC-I_{UE};
3) the AUSF 806 and the UE 802 associate a 16-bit counter, Counter_{UPU} (to be used for UPU protection), with the key K_{AUSF}. The AUSF 806 calculates the UPU-MAC-I_{AUSF} using the parameters received from the UDM 808 and delivers the UPU-MAC-I_{AUSF} and Counter_{UPU} to the UDM 808. If the ACK indication input is present, then the AUSF 806 also computes the UPU-XMAC-I_{UE} and return the computed UPU-XMAC-I_{UE} in the response to the UDM 808. The AUSF 806 computes the UPU-MAC-I_{AUSF} and UPU-XMAC-I_{UE}. The inclusion of UPU priority information, UPU capability check required information, UE parameters update header, and/or UE parameters update data in the calculation of UPU-MAC-I_{AUSF} allows the UE 802 to verify that it has not been tampered by any intermediary. The expected UPU-XMAC-I_{UE} allows the UDM 808 to verify that the UE 802 received the UE parameters update data correctly and performed the UE UPU capability check successfully when requested by the UDM 808; and/or
4) instead of UPU priority information, the following information can be used by the UE 802 in the UPU procedure to perform UE's UPU capability based UPU data provisioning: UPU capability check required information (e.g., required UPU data set type(s) support, UPU capability request). Then the description related to ‘UPU Priority Information’ may be applicable to UPU capability check required information.

In a third communication 816, the UDM 808 invokes a Nudm_SDM_Notification service operation which contains UPU priority information, UE parameters update data (i.e., the UPU data list and UPU header), UPU-MAC-I_{AUSF}, and/or Counter_{UPU} within the access and mobility subscription data. If the UDM requests an acknowledgement, it temporarily store the expected UPU-XMAC-I_{UE} along with the required UPU data set type(s) support information for the UE 802 corresponding to the ongoing UPU.

In a fourth communication 818, upon receiving the Nudm_SDM_Notification message, the AMF 804 sends a downlink (“DL”) NAS transport message to the served UE 802. The AMF 804 may include, in the DL NAS transport message, the transparent container received from the UDM 808 which contains the UPU priority information, UE parameters update data (i.e., the UPU data list and UPU header), UPU-MAC-I_{AUSF}, and Countercpt.

On receiving the DL NAS transport message, the UE 802 calculates 820 the UPU-MAC-I_{AUSF} in the same way as the AUSF 806 using the received UPU priority information, UPU parameters update header, UE parameters update data, and the Counterupu and verify whether it matches the UPU-MAC-I_{AUSF} value received in the DL NAS transport message. If the verification of UPU-MAC-I_{AUSF} is successful, the UE 802, in response to receiving the ‘UPU Priority Information’ with UPU capability check required indication, determines to perform the UE's UPU data set type capability check. The UE's UPU data set type capability check is performed by matching the UE's UPU capability to support various data types with the received ‘Required UPU data type(s) support’ provided by the network. If both the UE's UPU capability and the network provided ‘Required UPU data type(s) support’ matches successfully, then the UE 802 determines to store and use the UPU data provided by the network. If the UPU data contains any parameters that is protected by secured packet, the UE 802 shall forward the secured packet to the USIM. If the verification of UPU-MAC-I_{AUSF} is successful and the UPU data contains any parameters that are not protected by a secure packet, the UE 802 further update its stored parameters with the received parameters in UDM update data.

In a fifth communication 822, in response to receiving the ACK required indication from the network, if the UE 802 has successfully performed the UPU priority information and/or UPU capability check and the UE 802 has successfully verified and updated the UE parameters update data provided by the UDM 808, then the UE 802 generates the UPU-MAC-I_{UE} and determines to send the UPU capability check success indication to the network in the acknowledgement response (e.g., in UL NAS transport message) along with its UPU capabilities, which also may include an UPU header. Further the UE 802 sends the UL NAS transport message to the serving AMF 804 and includes the generated acknowledgement, UPU capability check success indication, UE's UPU capabilities, UPU header, and UPU-MAC-I_{UE} in a transparent container in the UL NAS transport message. In some embodiments, the UE 802 can also generate a negative acknowledgement in case the UPU capability check fails, and can include its UPU data set type capabilities so that the UDM 808 may retry only with the supported UPU data set types.

In a sixth communication 824, if a transparent container with the UPU-MAC-I_{UE} was received in the UL NAS transport message, the AMF 804 can send a Nudm_SDM_Info request message with the transparent container to the UDM 808. The transparent container contains the acknowledgement, the UPU capability check success indication, the UE's UPU capabilities, UPU header, and the UPU-MAC-I_{UE}.

The UDM 808, on receiving the transparent container with the acknowledgement, the UPU capability check success indication, the UE's UPU capabilities, UPU header, and the UPU-MAC-I_{UE}, the UDM 808 first compares 826 the received UPU-MAC-I_{UE} with the expected UPU-XMAC-I_{UE} that the UDM 808 stored temporarily in step 816.

If the ‘Required UPU Data Set Type(s) Support’ information provided by the network is the same as the UE 802 provided ‘UE's capability of UPU Data Set Type(s) Support’, then the UE 802 provided UPU-MAC-I_{UE} will be same as the UPU-XMAC-I_{UE} available in the UDM 808 or else, if the ‘UE's capability of UPU Data Set Type(s) Support’ has more information than the ‘Required UPU Data Set Type(s) Support’, then the UDM 808 requests the AUSF 806 for the new UPU-XMAC-I_{UE} computation and ACK verification. In certain embodiments, the UDM 808, on receiving the transparent container with the acknowledgement, the UPU capability check success indication, the UE's UPU capabilities, UPU header, and the UPU-MAC-I_{UE}, determines to request the AUSF 806 for the verification of acknowledgement response with the UPU capability check success indication, the UE's UPU capabilities, UPU header, then steps 828 through 832 may be performed.

In a seventh communication 828, the UDM 808 requests that the AUSF 806 generate a UPU-MAC-I_{UE} that considers the acknowledgement, UPU header, the UPU capability check success indication, and the UE capability information provided by the UE 802. The UDM 808 invokes the Nausf_UPUProtection_ACKVerification service operation by including the contents of the UPU transparent container received from the UE 802 except for the UPU-MAC-I_{UE} and the Counter_{UPU} (e.g., temporarily stored by the UDM 808 in step 816).

The AUSF 806 may use 830 the received Counter_{UPU} when calculating a new UPU-MAC-I_{UE}. The AUSF 806 computes the new UPU-MAC-I_{UE}.

In an eighth communication 832, upon reception of the new UPU-XMAC-I_{UE} from the AUSF 806 in a Nausf_UPUProtection_ACKVerification response service operation, the UDM 808 may compare 834 it to the UPU-MAC-I_{UE} received in step 824. If the verification is successful, the UDM 808 stores the received UE capability information for future use (e.g., to trigger subsequent UPU procedures for UPU data).

The UDM 808 may locally store or store in the UDR the received UPU capabilities (e.g., UPU data set type(s) supported by the UE 802) for the UE 802 along with the SUPI.

It should be noted that the processing described in FIG. 8 may be adopted with any new service operation message(s) to support UPU capability check and to perform successful a UE parameter update procedure involving the UE 802, the AMF 804, the AUSF 806, and the UDM 808, respectively.

In various embodiments, if the UE 802 determines at step 820 that it is not capable to support the ‘Required UPU data type(s) support’ provided by the network, then the UE 802 can send a UPU capability check failure indication in step 822. Then the UDM 808 in step 826 can store the UE capability received in step 824 and can record the UPU failure status corresponding to the UPU data set type in the subscription information or UE context along with the SUPI. If a legacy UE cannot understand the message received in step 818, then the UE 802 can drop the message at step 820.

In certain embodiments, there may be a UPU-MAC-I_{AUSF} generation function. In such embodiments, an AUSF may perform a UPU-MAC-I_{AUSF} computation. Moreover, the UE may compute UPU-MAC-I_{AUSF} similar to the AUSF for the UPU-MAC-I_{AUSF} verification as follows: 1) when deriving a UPU-MAC-I_{AUSF} from K_{AUSF}, the following parameters may be used to form an input S to a key derivation function (“KDF”) with the following: a) FC=0x7B; b) P0=UE parameters update data; c) L0=length of UE parameters update data; d) P1=CounterUPU; e) L1=length of CounterUPU; f) P2=UPU priority information and/or UPU capability check required information; g) L2=length of UPU priority information and/or UPU capability check required information; h) P3=UE parameters update header; i) L3=length of UE parameters update header; j) P4=required UPU data set type information; and/or k) L4=length of required UPU data set type information. In such embodiments, the input key may be K_{AUSF}. The UPU-MAC-I_{AUSF} is identified with the 128 least significant bits of the output of the KDF.

In some embodiments, there may be a UPU-XMAC-I_{UE} generation function. In such embodiments, the AUSF, with ACK, UPU priority information and/or UPU capability check required information, performs UPU-MAC-I_{AUSF} computation. Moreover, when deriving a UPU-MAC-I_{UE} from K_{AUSF}, the following parameters shall be used to form an input S to a KDF with the following: 1) FC=0x7C; 2) P0=0x02 (e.g., UPU acknowledgement: verified the UE parameters update data and UPU priority information and/or UPU capability check required information successfully); 3) L0=length of UPU acknowledgement (e.g., 0x00 0x02); 4) P1=Counter_{UPU}; 5) L1=length of Counter_{UPU}; 6) P2=UE parameters update header; 7) L2=length of UE parameters update header; 8) P3=required UPU data set type(s) support; and/or 9) L3=length of required UPU data set type(s) support. In such embodiments, the input key shall be K_{AUSF}. The UPU-MAC-I_{UE} is identified with the 128 least significant bits of the output of the KDF.

In various embodiments, there may be a UPU-MAC-I_{UE} generation function. In such embodiments, the UE after a successful UPU capability check and update and/or storing of UPU data derives a UPU-MAC-I_{UE} from the K_{AUSF}, the following parameters ay be used to form the input S to the KDF: 1) FC=0x7C; 2) P0=0x02 (e.g., UPU acknowledgement: verified the UE parameters update data and UPU priority information and/or UPU capability check required information successfully); 3) L0=length of UPU acknowledgement (e.g., 0x00 0x02); 4) P1=Counter_{UPU}; 5) L1=length of Counter_{UPU}; 6) P2=UE parameters update header; 7) L2=Length of UE parameters update header; 8) P3=UE's capability of UPU data set type(s) support; and/or 9) L3=length of UE's capability of UPU data set type(s) support. In certain embodiments, UPU-MAC-I_{UE} generation function described may be alternatively called as UPU-MAC-I_{UE}-Verification generation function and/or UPU-MAC-I_{UE}-Response.

In some embodiments, steps described in the first embodiment may be applicable to a steering of roaming (“SoR”) procedure as enhancement to SoR for performing the SoR related UE's capability check and related SoR parameters provisioning, where the only change in the description of FIG. 8 is that all ‘UPU’ related wording should be replaced with the word ‘SoR’.

In the first embodiment, the ‘Required UPU data type(s) support’ may be alternatively termed ‘Expected UPU data type(s) support’.

In a second embodiment, there may be a UPU capability request and/or response to support a UPU procedure.

The second embodiment describes an alternative to the first embodiment for indicating the UE capability check request from the network to the UE in a UPU parameters update header. In response, the UE can send the indications in the UE parameter update header if it is capable to support the data types of UPU data provided by the UDM as ‘required/expected to be supported’.

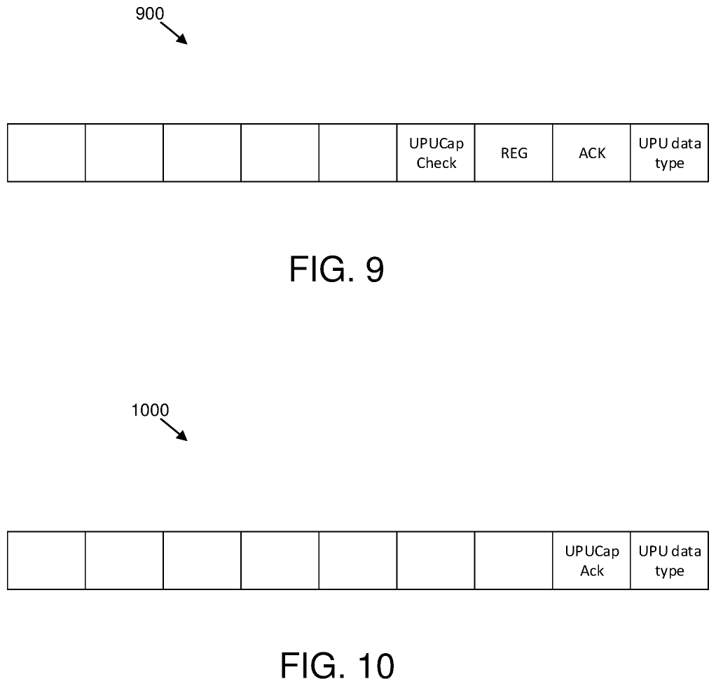

FIG. 9 is a schematic block diagram illustrating one embodiment of UE parameters update header 900 for UE parameters update data type with value “0” (e.g., network to UE). The UE parameters update header 900 may include a UPU capability check (“UPUCapCheck”), a REG, an ACK, and a UPU data type.

Specifically, FIG. 9 shows how the network can request the UPUCapCheck in the UPU header to invoke the UE to perform the UPU capability check at its side based on the ‘Required UPU capability/data set type(s) support information’ provided by the UDM. If the UDM determines to request the UPUCapCheck from the UE, then the UDM can set the UPUCapCheck as ‘1’, else if the UDM determines to not request UPUCapCheck from the UE, then the UDM can be set as ‘0’ in the UPU header.

FIG. 10 is a schematic block diagram illustrating one embodiment of UE parameters update header 1000 for UE parameters update data type with value “1” (e.g., UE to network). The UE parameters update header 1000 may include a UPU capability acknowledgement (“UPUCapAck”) and a UPU data type.

Specifically, FIG. 10 shows how the UE can indicate its capability to support the ‘required UPU data set types’ provided by the network. If the UE supports all the ‘Required UPU data type(s) support’ as provided by the UDM, then the UPUCapAct can contain the value ‘1’ else if the UE does not support one or all the ‘Required UPU data type(s) support’ as provided by the UDM, then the UPUCapAck can contain the value ‘0’ in the UPU header.

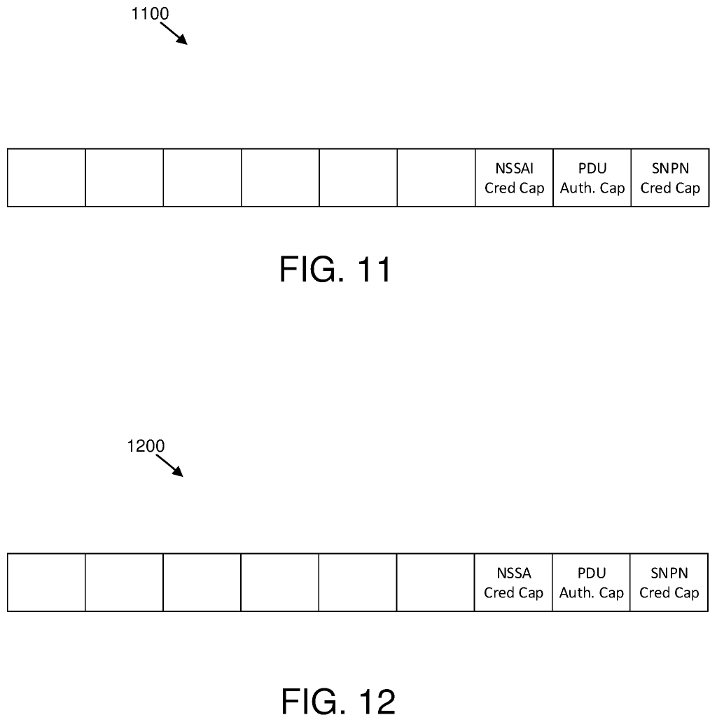

FIG. 11 is a schematic block diagram illustrating one embodiment of required and/or expected UE parameters update data set type(s) 1100 (e.g., network to UE). The UE parameters update data set type(s) 1100 includes an NSSAI credibility capability, a PDU authentication capability, and a SNPN credibility capability.

Specifically, FIG. 11 shows how the network can provide the expected and/or required UE parameters update data set type(s) information element to the UE during a UPU procedure, where each data set type can reserve a bit to indicate if it is required to be supported (e.g., bit 1) or not (e.g., bit 0). The ‘expected/required UE parameters update data set type(s) information element’ can be provided by the network to the UE as part of the UE parameters update transparent container information element for UE parameters update data type with value ‘0’.

FIG. 12 is a schematic block diagram illustrating one embodiment of UE parameters update data set type(s) 1200 supported by the UE (e.g., UE to network). The UE parameters update data set type(s) 1200 includes an NSSAI credibility capability, a PDU authentication capability, and a SNPN credibility capability.

Specifically, FIG. 12 shows how the UE can provide the supported UE parameters update data set type(s) information element (e.g., UPU capabilities supported by the UE) to the network during a UPU procedure, where each data set type can reserve a bit to indicate if it is supported (e.g., bit 1) or not (e.g., bit 0). The ‘Supported UE parameters update data set type(s) information element’ can be provided by the UE to the network as part of the UE parameters update transparent container information element for UE parameters update data type with value ‘1’.

In some embodiments, steps described in the second embodiment may be applicable to a SoR procedure as enhancement to SoR for performing the SoR related UE's capability check and related SoR parameters provisioning, where the only change in the is that all ‘UPU’ related wording should be replaced with the word ‘SoR’.

In the second embodiment, the ‘Required UPU data type(s) support’ may be alternatively termed ‘Expected UPU data type(s) support”.

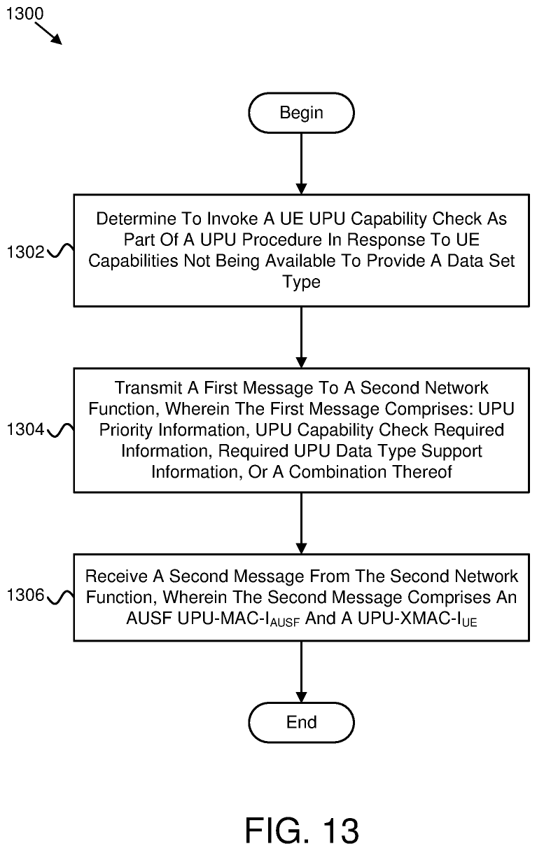

FIG. 13 is a flow chart diagram illustrating one embodiment of a method 1300 for performing a UPU capability check. In some embodiments, the method 1300 is performed by an apparatus, such as the network unit 104. In certain embodiments, the method 1300 may be performed by a processor executing program code, for example, a microcontroller, a microprocessor, a CPU, a GPU, an auxiliary processing unit, a FPGA, or the like.

In various embodiments, the method 1300 includes determining 1302, at a first network function, to invoke a UE UPU capability check as part of a UPU procedure in response to UE capabilities not being available to provide a data set type. In some embodiments, the method 1300 includes transmitting 1304 a first message to a second network function, wherein the first message includes: UPU priority information, UPU capability check required information, required UPU data type support information, or a combination thereof. In certain embodiments, the method 1300 includes receiving 1306 a second message from the second network function. The second message includes an AUSF UPU-MAC-I_{AUSF} and a UPU-XMAC-I_{UE}.

In certain embodiments, the method 1300 further comprises transmitting a third message to a third network function, wherein the third message comprises a notification message indicating to perform the UPU procedure, the notification message comprises the UPU priority information, the UPU-MAC-I_{AUSF}, and data, and the UPU priority information comprises UPU capability check required indications, required UPU data set type support information, a UPU capability request, or a combination thereof. In some embodiments, the method 1300 further comprises receiving a fourth message from the third network function, wherein the fourth message comprises a UPU capability check success indication and a UPU-MAC-I_{UE}. In various embodiments, the method 1300 further comprises verifying the UPU-MAC-I_{UE} with the UPU-XMAC-I_{UE} in response to receiving the UPU capability check success indication.

In one embodiment, the method 1300 further comprises, in response to the UPU-MAC-I_{UE} not matching the UPU-XMAC-I_{UE}, transmitting a fifth message to the second network function, wherein the fifth message comprises an acknowledgment verification message, and the acknowledgement verification message comprises the UPU capability check success indication. In certain embodiments, the method 1300 further comprises receiving a sixth message from the second network function, wherein the sixth message comprises an acknowledgment verification response, and the acknowledgement verification response comprises an updated UPU-XMAC-I_{UE}. In some embodiments, the UPU-MAC-I_{UE} is generated with inputs that include: the UPU priority information, UPU capability check acknowledgement information, a UPU header, a length of the UPU header, or a combination thereof.

In various embodiments, the third network function comprises an AMF. In one embodiment, the UPU-MAC-I_{AUSF} and the UPU-XMAC-I_{UE} are generated with inputs that include: the UPU priority information, a length of the UPU priority information, a UPU header, a length of the UPU header, the required UPU data set type information, a length of the required UPU data set type information, or a combination thereof. In certain embodiments, the first network function comprises a UDM.

In some embodiments, the second network function comprises an AUSF. In various embodiments, the method 1300 further comprises transmitting: a UE capability check request indication, an expected UPU data type list indication, a required UPU data type list indication, or a combination thereof in a UE parameter update header to the UE via a third network function. In one embodiment, the method 1300 further comprises receiving from the UE; a UE capability acknowledgement indication, supported UE parameters update data set type indication per data type, or a combination thereof in a UE parameter update header.

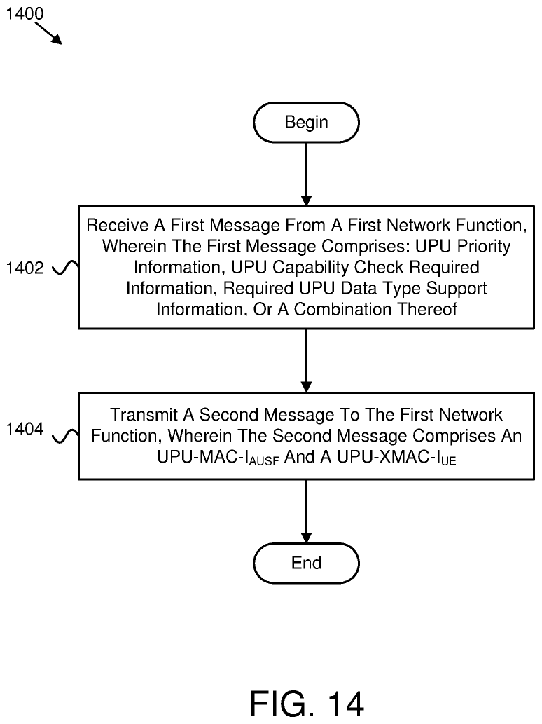

FIG. 14 is a flow chart diagram illustrating another embodiment of a method 1400 for performing a UPU capability check. In some embodiments, the method 1400 is performed by an apparatus, such as the network unit 104. In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes receiving 1402, at a second network function, a first message from a first network function. The first message includes: UPU priority information, UPU capability check required information, required UPU data type support information, or a combination thereof. In some embodiments, the method 1400 includes transmitting 1404 a second message to the first network function. The second message includes an UPU-MAC-I_{AUSF} and a UPU-XMAC-I_{UE}.

In certain embodiments, the first network function comprises a UDM. In some embodiments, the second network function comprises an AUSF.

In one embodiment, an apparatus comprises a first network function, the apparatus further comprising: a processor to determine to invoke a UE UPU capability check as part of a UPU procedure in response to UE capabilities not being available to provide a data set type; a transmitter to transmit a first message to a second network function, wherein the first message comprises: UPU priority information, UPU capability check required information, required UPU data type support information, or a combination thereof; and a receiver to receive a second message from the second network function, wherein the second message comprises an UPU-MAC-I_{AUSF} and a UPU-XMAC-I_{UE}.

In certain embodiments, the transmitter further to transmit a third message to a third network function, the third message comprises a notification message indicating to perform the UPU procedure, and the notification message comprises the UPU priority information, the UPU-MAC-I_{AUSF}, and data, and the UPU priority information comprises UPU capability check required indications, required UPU data set type support information, a UPU capability request, or a combination thereof.

In some embodiments, the receiver to receive a fourth message from the third network function, and the fourth message comprises a UPU capability check success indication and a UPU-MAC-I_{UE}.

In various embodiments, the processor further to verify the UPU-MAC-I_{UE} with the UPU-XMAC-I_{UE} in response to receiving the UPU capability check success indication.

In one embodiment, in response to the UPU-MAC-I_{UE} not matching the UPU-XMAC-I_{UE}, the transmitter to transmit a fifth message to the second network function, the fifth message comprises an acknowledgment verification message, and the acknowledgement verification message comprises the UPU capability check success indication.

In certain embodiments, the receiver further to receive a sixth message from the second network function, the sixth message comprises an acknowledgment verification response, and the acknowledgement verification response comprises an updated UPU-XMAC-I_{UE}.

In some embodiments, the UPU-MAC-I_{UE} is generated with inputs that include: the UPU priority information, UPU capability check acknowledgement information, a UPU header, a length of the UPU header, or a combination thereof.

In various embodiments, the third network function comprises an AMF.

In one embodiment, the UPU-MAC-I_{AUSF} and the UPU-XMAC-I_{UE} are generated with inputs that include: the UPU priority information, a length of the UPU priority information, a UPU header, a length of the UPU header, the required UPU data set type information, a length of the required UPU data set type information, or a combination thereof.

In certain embodiments, the first network function comprises a UDM.

In some embodiments, the second network function comprises an AUSF.

In various embodiments, the transmitter further to transmit: a UE capability check request indication, an expected UPU data type list indication, a required UPU data type list indication, or a combination thereof in a UE parameter update header to the UE via a third network function.

In one embodiment, the receiver further to receive from the UE: a UE capability acknowledgement indication, supported UE parameters update data set type indication per data type, or a combination thereof in a UE parameter update header.

In one embodiment, a method at a first network function, the method comprising: determining to invoke a UE UPU capability check as part of a UPU procedure in response to UE capabilities not being available to provide a data set type; transmitting a first message to a second network function, wherein the first message comprises: UPU priority information, UPU capability check required information, required UPU data type support information, or a combination thereof; and receiving a second message from the second network function, wherein the second message comprises an AUSF UPU-MAC-I_{AUSF} and a UPU-XMAC-I_{UE}.

In certain embodiments, the method further comprises transmitting a third message to a third network function, wherein the third message comprises a notification message indicating to perform the UPU procedure, the notification message comprises the UPU priority information, the UPU-MAC-I_{AUSF}, and data, and the UPU priority information comprises UPU capability check required indications, required UPU data set type support information, a UPU capability request, or a combination thereof.

In some embodiments, the method further comprises receiving a fourth message from the third network function, wherein the fourth message comprises a UPU capability check success indication and a UPU-MAC-I_{UE}.

In various embodiments, the method further comprises verifying the UPU-MAC-I_{UE} with the UPU-XMAC-I_{UE} in response to receiving the UPU capability check success indication.

In one embodiment, the method further comprises, in response to the UPU-MAC-I_{UE} not matching the UPU-XMAC-I_{UE}, transmitting a fifth message to the second network function, wherein the fifth message comprises an acknowledgment verification message, and the acknowledgement verification message comprises the UPU capability check success indication.

In certain embodiments, the method further comprises receiving a sixth message from the second network function, wherein the sixth message comprises an acknowledgment verification response, and the acknowledgement verification response comprises an updated UPU-XMAC-I_{UE}.

In some embodiments, the UPU-MAC-I_{UE} is generated with inputs that include: the UPU priority information, UPU capability check acknowledgement information, a UPU header, a length of the UPU header, or a combination thereof.

In various embodiments, the third network function comprises an AMF.

In one embodiment, the UPU-MAC-I_{AUSF} and the UPU-XMAC-I_{UE} are generated with inputs that include: the UPU priority information, a length of the UPU priority information, a UPU header, a length of the UPU header, the required UPU data set type information, a length of the required UPU data set type information, or a combination thereof.

In certain embodiments, the first network function comprises a UDM.

In some embodiments, the second network function comprises an AUSF.

In various embodiments, the method further comprises transmitting: a UE capability check request indication, an expected UPU data type list indication, a required UPU data type list indication, or a combination thereof in a UE parameter update header to the UE via a third network function.

In one embodiment, the method further comprises receiving from the UE: a UE capability acknowledgement indication, supported UE parameters update data set type indication per data type, or a combination thereof in a UE parameter update header.

In one embodiment, an apparatus comprises a second network function, the apparatus further comprising: a receiver to receive a first message from a first network function, wherein the first message comprises: UPU priority information, UPU capability check required information, required UPU data type support information, or a combination thereof; and a transmitter to transmit a second message to the first network function, wherein the second message comprises an UPU-MAC-IAUSF and a UPU-XMAC-IUE.

In certain embodiments, the first network function comprises a UDM.

In some embodiments, the second network function comprises an AUSF.

In one embodiment, a method at a second network function, the method comprising: receiving a first message from a first network function, wherein the first message comprises: UPU priority information, UPU capability check required information, required UPU data type support information, or a combination thereof; and transmitting a second message to the first network function, wherein the second message comprises an UPU-MAC-I_{AUSF} and a UPU-XMAC-I_{UE}.

In certain embodiments, the first network function comprises a UDM.

In some embodiments, the second network function comprises an AUSF.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a first network function, the apparatus comprising:
at least one memory; and
at least one processor coupled with the at least one memory and configured to cause the apparatus to:
determine to invoke a user equipment (UE) parameters update (UPU) capability check as part of a UPU procedure in response to UE capabilities not being available to provide a data set type;
transmit a first message to a second network function, wherein the first message comprises: UPU priority information, UPU capability check required information, required UPU data type support information, or a combination thereof; and
receive a second message from the second network function, wherein the second message comprises an authentication server function (AUSF) UPU medium access control (MAC) integrity (I) (UPU-MAC-I_{AUSF}) and a UE UPU expected MAC (XMAC) I (UPU-XMAC-I_{UE}).

2. The apparatus of claim 1, wherein the at least one processor is configured to cause the apparatus to transmit a third message to a third network function, the third message comprises a notification message indicating to perform the UPU procedure, and the notification message comprises the UPU priority information, the UPU-MAC-I_{AUSF}, and data, and the UPU priority information comprises UPU capability check required indications, required UPU data set type support information, a UPU capability request, or a combination thereof.

3. The apparatus of claim 2, wherein the at least one processor is configured to cause the apparatus to receive a fourth message from the third network function, and the fourth message comprises a UPU capability check success indication and a UPU-MAC-I_{UE}.

4. The apparatus of claim 3, wherein the at least one processor is configured to cause the apparatus to verify the UPU-MAC-I_{UE} with the UPU-XMAC-I_{UE}in response to receiving the UPU capability check success indication.

5. The apparatus of claim 4, wherein, in response to the UPU-MAC-I_{UE} not matching the UPU-XMAC-I_{UE}, the at least one processor is configured to cause the apparatus to transmit a fifth message to the second network function, the fifth message comprises an acknowledgment verification message, and the acknowledgement verification message comprises the UPU capability check success indication.

6. The apparatus of claim 5, wherein the at least one processor is configured to cause the apparatus to receive a sixth message from the second network function, the sixth message comprises an acknowledgment verification response, and the acknowledgement verification response comprises an updated UPU-XMAC-I_{UE}.

7. The apparatus of claim 3, wherein the UPU-MAC-I_{UE} is generated with inputs that include: the UPU priority information, UPU capability check acknowledgement information, a UPU header, a length of the UPU header, or a combination thereof.

8. The apparatus of claim 2, wherein the third network function comprises an access and mobility management function (AMF).

9. The apparatus of claim 1, wherein the UPU-MAC-I_{AUSF} and the UPU-XMAC-I_{UE} are generated with inputs that include: the UPU priority information, a length of the UPU priority information, a UPU header, a length of the UPU header, required UPU data set type information, a length of the required UPU data set type information, or a combination thereof.

10. The apparatus of claim 1, wherein the first network function comprises a unified data management (UDM).

11. The apparatus of claim 1, wherein the second network function comprises an AUSF.

12. The apparatus of claim 1, wherein the at least one processor is configured to cause the apparatus to transmit: a UE capability check request indication, an expected UPU data type list indication, a required UPU data type list indication, or a combination thereof in a UE parameter update header to the UE via a third network function.

13. The apparatus of claim 1, wherein the at least one processor is configured to cause the apparatus to receive from the UE: a UE capability acknowledgement indication, supported UE parameters update data set type indication per data type, or a combination thereof in a UE parameter update header.

14. A method of performing a first network function, the method comprising:
determining to invoke a user equipment (UE) parameters update (UPU) capability check as part of a UPU procedure in response to UE capabilities not being available to provide a data set type;
transmitting a first message to a second network function, wherein the first message comprises: UPU priority information, UPU capability check required information, required UPU data type support information, or a combination thereof; and
receiving a second message from the second network function, wherein the second message comprises an authentication server function (AUSF) UPU medium access control (MAC) integrity (I) (UPU-MAC-I_{AUSF}) and a UE UPU expected MAC (XMAC) I (UPU-XMAC-I_{UE}).

15. An apparatus for performing a second network function, the apparatus comprising:
at least one memory; and
at least one processor coupled with the at least one memory and configured to cause the apparatus to:
receive a first message from a first network function, wherein the first message comprises: UPU priority information, UPU capability check required information, required UPU data type support information, or a combination thereof; and
transmit a second message to the first network function, wherein the second message comprises an authentication server function (AUSF) UPU medium access control (MAC) integrity (I) (UPU-MAC-I_{AUSF}) and a UE UPU expected MAC (XMAC) I (UPU-XMAC-I_{UE}).

16. The method of claim 14, further comprising transmitting a third message to a third network function, the third message comprises a notification message indicating to perform the UPU procedure, and the notification message comprises the UPU priority information, the UPU-MAC-I_{AUSF}, and data, and the UPU priority information comprises UPU capability check required indications, required UPU data set type support information, a UPU capability request, or a combination thereof.

17. The method of claim 16, further comprising receiving a fourth message from the third network function, and the fourth message comprises a UPU capability check success indication and a UPU-MAC-I_{UE}.

18. The method of claim 17, further comprising verifying the UPU-MAC-I_{UE} with the UPU-XMAC-I_{UE} in response to receiving the UPU capability check success indication.

19. The method of claim 18, further comprising, in response to the UPU-MAC-I_{UE} not matching the UPU-XMAC-I_{UE}, transmitting a fifth message to the second network function, the fifth message comprises an acknowledgment verification message, and the acknowledgement verification message comprises the UPU capability check success indication.

20. A method of performing a second network function, the method comprising:
receiving a first message from a first network function, wherein the first message comprises: UPU priority information, UPU capability check required information, required UPU data type support information, or a combination thereof; and
transmitting a second message to the first network function, wherein the second message comprises an authentication server function (AUSF) UPU medium access control (MAC) integrity (I) (UPU-MAC-IAUSF) and a UE UPU expected MAC (XMAC) I (UPU-XMAC-IUE).
